(19) United States
(12) Patent Application Publication
(10) Pub. No.: US 2017/0234219 A1
(43) Pub. Date: Aug. 17, 2017

(54) SYNGAS BURNER SYSTEM FOR A GAS TURBINE ENGINE

(71) Applicant: Siemens Energy, Inc., Orlando, FL (US)

(72) Inventors: Vinayak V. Barve, Oviedo, FL (US); Rafik N. Rofail, Oviedo, FL (US); Samer P. Wasif, Oviedo, FL (US); Clifford E. Johnson, Orlando, FL (US); Khalil Farid Abou-Jaoude, Winter Springs, FL (US); Stephan Buch, Bochum (DE); Bernd Prade, Mülheim (DE); Jürgen Meisl, Mülheim an der Ruhr (DE)

(21) Appl. No.: 15/504,504

(22) PCT Filed: Sep. 11, 2014
(86) PCT No.: PCT/US2014/055048

§ 371 Date: Feb. 16, 2017

(51) Int. Cl. F02C 3/22; F23R 3/28; F02C 7/228

(52) U.S. Cl. CPC F02C 3/22; F02C 7/228; F23R 3/28

(57) ABSTRACT

A fuel burner system (10) for a turbine engine (12) configured to operate with syngas fuel, whereby the fuel burner system (10) is configured to reduce nozzle and combustor basket temperatures is disclosed. The fuel burner system (10) may include a plurality of first and second fuel injection ports (16) positioned within a combustor (18), whereby the first fuel injection ports (14) are larger than the second fuel injection ports (16). One or more air injection ports (20) may be aligned with the first fuel injection ports (14). During operation, fuel injected into the combustor (18) from the first fuel injection ports (14) mixes better with the incoming air, causing reduced NOx emissions and lower flame temperatures. Also, the regions between adjacent air injection ports (20), which typically run the hottest, are cooler than conventional combustion system due, in part, to the smaller, second fuel injection ports (16) aligned with regions (22) between adjacent air injection ports (20).

### FIELD OF THE INVENTION

This invention is directed generally to turbine engines, and more particularly to fuel burner systems for turbine engines.

### BACKGROUND

Typically, gas turbine engines include a plurality of injectors for injecting fuel into a combustor to mix with air upstream of a flame zone. The fuel injectors of conventional turbine engines may be arranged in one of at least three different schemes. Fuel injectors may be positioned in a lean premix flame system in which fuel is injected in the air stream far enough upstream of the location at which the fuel/air mixture is ignited that the air and fuel are completely mixed upon burning in the flame zone. Fuel injectors may also be configured in a diffusion flame system such that fuel and air are mixed and burned simultaneously. In yet another configuration, often referred to as a partially premixed system, fuel injectors may inject fuel upstream of the flame zone a sufficient distance that some of the air is mixed with the fuel. Partially premixed systems are combinations of a lean premix flame system and a diffusion flame system.

Typically, gas turbine engines configured to burn syngas include a combustor configured to burn syngas formed basically of H2 and CO and a diluent such as N2 or steam. The combustors are often a derivative of diffusion flame burners and burn a temperatures close to the stoichiometric flame temperatures, which increases the thermal load on the combustor basket, leading to damage of the combustor basket. Thus, a need exists to accommodate the increased temperatures created with using syngas as fuel in gas turbine engines.

### SUMMARY OF THE INVENTION

A fuel burner system for a turbine engine configured to operate with syngas fuel, whereby the fuel burner system is configured to reduce nozzle and combustor basket temperatures is disclosed. The fuel burner system may include a one or more first and second fuel injection ports positioned within a combustor, whereby the first fuel injection ports are larger than the second fuel injection ports. One or more air injection ports may be aligned with the first fuel injection ports. During operation, fuel injected into the combustor from the first fuel injection ports mixes better with the incoming air, causing reduced NOx emissions and lower flame temperatures. Also, the regions between adjacent air injection ports, which typically run the hottest, are cooler than conventional combustion system due, in part, to the smaller, second fuel injection ports aligned with the regions between adjacent air injection ports.

The fuel burner system for a turbine engine may include one or more combustors formed from a combustor housing and one or more nozzle caps. The nozzle cap may include one or more first fuel injection ports and one or more second fuel injection ports. The first fuel injection port and the second fuel injection port may be connected to independent fuel supply lines that are each controlled with separate valves. The first fuel injection port may be larger than the second fuel injection port. The first fuel injection port may be circumferentially aligned with at least one air injection port when viewed upstream along a longitudinal axis of the combustor. The first fuel injection port may include a plurality first fuel injection ports forming a circular pattern on the nozzle cap. The second fuel injection port may also include a plurality second fuel injection ports forming a circular pattern on the nozzle cap. In at least one embodiment, each of the first fuel injection ports may be aligned with at least one air injection port. The plurality of first fuel injection ports and the plurality of second fuel injection ports may be positioned in an alternating, circular pattern.

In at least one embodiment, the air injection port may be offset downstream from a downstream surface of the nozzle cap. The air injection port may be formed from a plurality of air injection ports circumferentially aligned with the first fuel injection port. The plurality of air injection ports may be offset downstream from a downstream surface of the nozzle cap. The fuel burner system may also include one or more third fuel injection ports positioned radially inward of the first fuel injection port. The third fuel injection port may be formed from a plurality of third fuel injection ports positioned radially inward of the first fuel injection port and forming a ring of third fuel injection ports. The third fuel injection port may be smaller than the second fuel injection port.

During use, fuel is emitted into the combustor housing via the first injection stage. In at least one embodiment, between about 80 percent and about 90 percent of total fuel injection into the combustor may occur through the first fuel injection stage. The fuel emitted from the first fuel injection stage may flow from the first and second fuel injection ports. The fuel flowing from the first fuel injection port mixes with air emitted from the air injection ports proximate to the first fuel injection ports.

An advantage of the fuel burner system is that with the air injection ports being circumferentially aligned with the first fuel injection ports and being larger than the second fuel injection ports, the fuel is mixed with the air better than conventional systems resulting in lower NOx emissions and lower flame temperatures.

Another advantage of the fuel burner system is that the smaller second fuel injection ports are positioned in an alternating manner between the larger first fuel injection ports. The second fuel injection ports emit less fuel than the first fuel injection ports. As such, the regions between the first fuel injection ports experience less combustion and are cooler than conventional systems, allowing for lower temperatures of the combustor housing and related components. The fuel burner system, thus, tailors the first and second fuel injection ports to optimize combustor temperatures, emissions, and combustion dynamics over a wide range of fuels.

Yet another advantage of the fuel burner system is that the fuel burner system enables the syngas combustors to operate with a wide range of fuel compositions, such as to accommodate a significant Wobbe Index variation or LHV variation. The fuel burner system enables the syngas combustor to use a wide range of fuel compositions without detrimental impacts that otherwise would substantially increase combustor basket temperatures in conventional systems.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a portion of a turbine engine including the fuel burner system.

FIG. 2 is detailed, cross-sectional side view of a combustor with the fuel burner system taken at section line 2-2 in FIG. 1.

FIG. 3 is a cross-sectional, end view of the nozzle cap taken at section line 3-3 in FIG. 2.

FIG. 4 is a cross-sectional view of the combustor and nozzle cap taken at section line 4-4 in FIG. 2.

FIG. 5 is a cross-sectional, end view of another embodiment of the fuel burner system with the nozzle cap taken at section line 3-3 in FIG. 2.

### DETAILED DESCRIPTION OF THE INVENTION

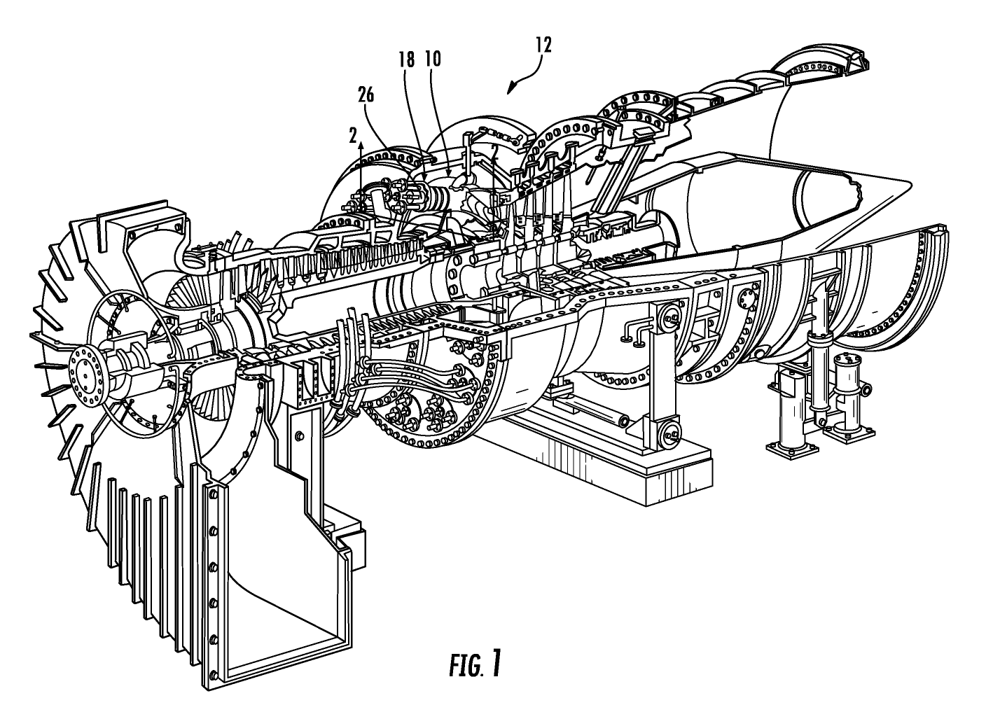

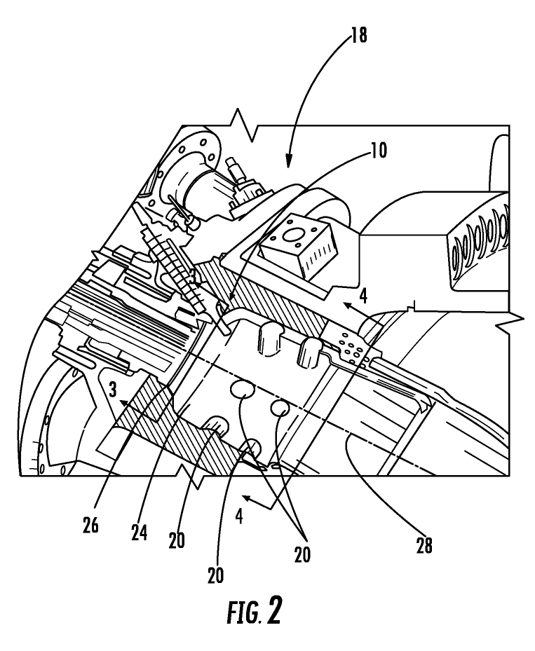

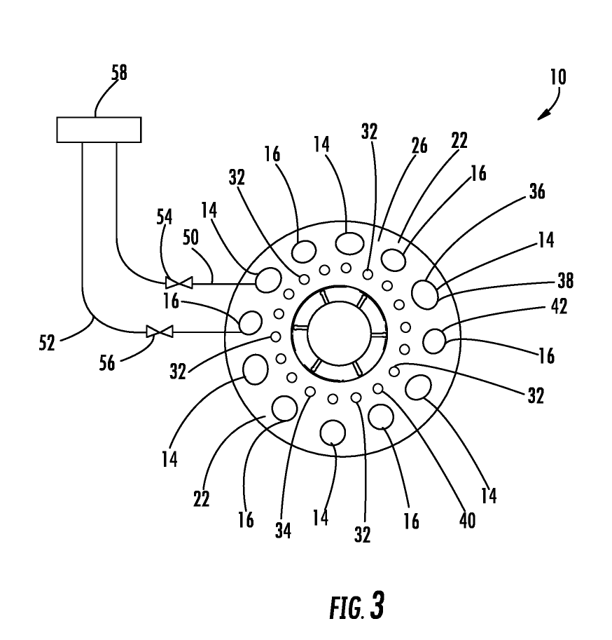

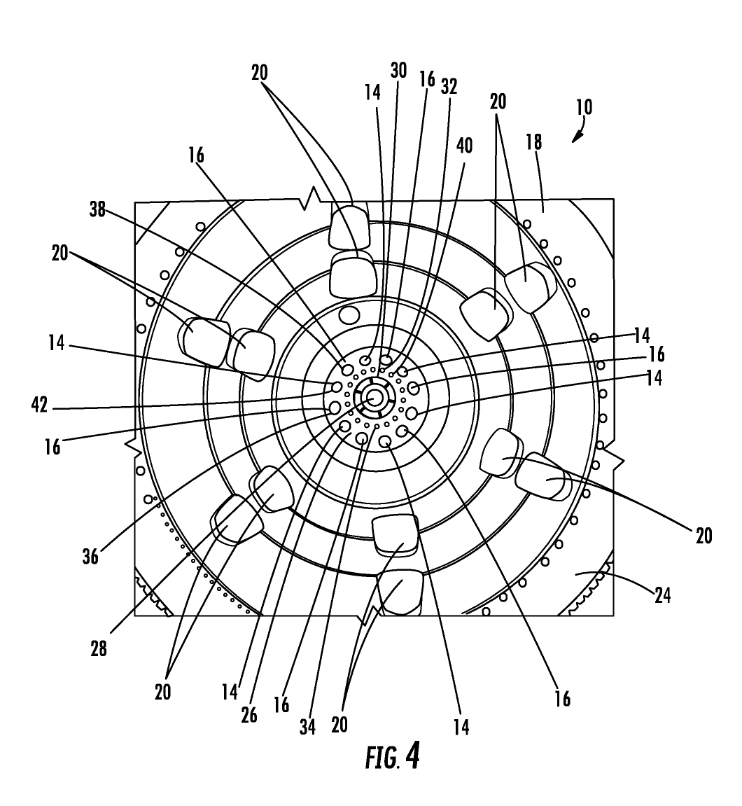

As shown in FIGS. 1-5, a fuel burner system 10 for a turbine engine 12 configured to operate with syngas fuel, whereby the fuel burner system 10 is configured to reduce nozzle and combustor basket temperatures is disclosed. The fuel burner system 10 may include a one or more first and second fuel injection ports 14, 16, as shown in FIGS. 3 and 4, positioned within a combustor 18, whereby the first fuel injection ports 14 are larger than the second fuel injection ports 16. One or more air injection ports 20 may be aligned with the first fuel injection ports 14. During operation, fuel injected into the combustor 18 from the first fuel injection ports 14 mixes better with the incoming air, causing reduced NOx emissions and lower flame temperatures. Also, the regions 22 between adjacent air injection ports 20, which typically run the hottest, are cooler than conventional combustion system due, in part, to the smaller, second fuel injection ports 16 aligned with the regions 22 between adjacent air injection ports 20.

In at least one embodiment, the fuel burner system 10 for a turbine engine 12 may include one or more combustors 18 formed from a combustor housing 24 and one or more nozzle caps 26. The nozzle cap 26 may include one or more first fuel injection ports 14 and one or more second fuel injection ports 16. The first fuel injection port 14 may be larger than the second fuel injection port 16. The first fuel injection port 14 may be circumferentially aligned with one or more air injection ports 20 when viewed upstream along a longitudinal axis 28 of the combustor 18. In at least one embodiment, the fuel burner system 10 may include a plurality first fuel injection ports 14 forming a circular pattern on the nozzle cap 26. In at least one embodiment, the plurality of first fuel injection ports 14 may be formed by six first fuel injection ports 14. In other embodiments, another number of first fuel injection ports 14 may be used. The first fuel injection ports 14 have circular outlets 42 or any other appropriate cross-sectional shape.

The fuel burner system 10 may be configured such that the first fuel injection port 14 and the second fuel injection port 16 are connected to independent fuel supply lines 50, 52 that are each controlled with separate valves 54, 56. The first fuel injection port 14 may be supplied with fuel controlled via one or more valves 54 on supply line 50, which is in communication with a fuel source 58. The second fuel injection port 16 may be supplied with fuel controlled via one or more valves 56 on supply line 52, which is in communication with a fuel source 58. The valves 54, 56 may supply fuel to the first fuel injection port 14 and the second fuel injection port 16 at a similar rate or at different rates.

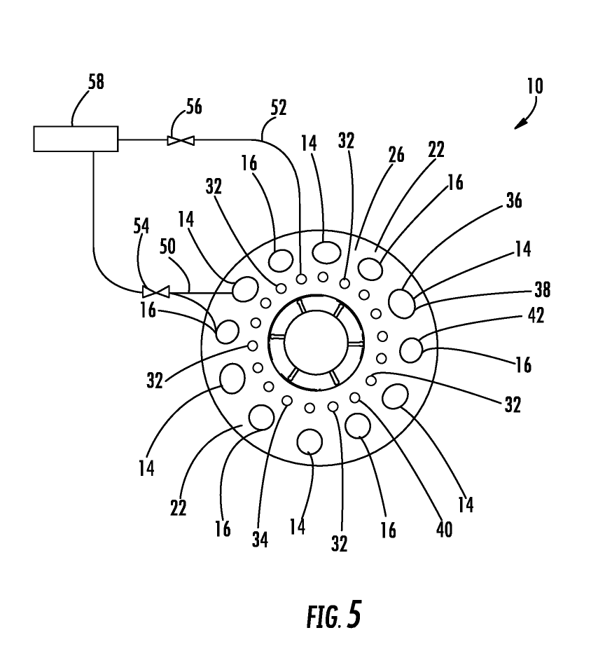

In another embodiment, as shown in FIG. 5, the fuel burner system 10 may be configured such that the first fuel injection port 14 and the second fuel injection port 16 are controlled via supply line 50. The third fuel injection ports 32 may be controlled independently from the first and second fuel injection ports 14, 16 via supply line 56 and valve 52. The first and second fuel injection ports 14, 16 may be supplied with fuel controlled via one or more valves 54 on supply line 50, which is in communication with a fuel source 58. The third fuel injection port 32 may be supplied with fuel controlled via one or more valves 56 on supply line 52, which is in communication with a fuel source 58. The valves 54, 56 may supply fuel to the first and second fuel injection ports 14, 16 at the same rate and to the third fuel injection port 32 at a similar rate or at different rates.

The fuel burner system 10 may include a plurality second fuel injection ports 16 forming a circular pattern on the nozzle cap 26. In at least one embodiment, the plurality of second fuel injection ports 16 may be formed by six second fuel injection ports 16. In other embodiments, another number of second fuel injection ports 16 may be used. The second fuel injection ports 16 may have circular outlets or any other appropriate cross-sectional shape. In at least one embodiment, the first fuel injection ports 14 and the second fuel injection ports 16 may be positioned in an alternating, circular pattern.

In at least one embodiment, the fuel burner system 10 may include a plurality of air injection ports 20. In at least one embodiment, the air injection ports 20 may be formed by six air injection ports 20. In other embodiments, another number of air injection ports 20 may be used. The air injection ports 20 may be positioned in a combustor housing 24. The air injection ports 20 may have circular outlets or any other appropriate cross-sectional shape. The air injection port 20 may be offset downstream from a downstream surface 30 of the nozzle cap 26. In at least one embodiment, the air injection port 20 may be formed from a plurality of air injection ports 20 circumferentially aligned with a first fuel injection port 20. Each of the first fuel injection ports 14 may be aligned with one or more air injection ports 20. As shown in FIG. 4, each first fuel injection port 14 may be aligned with two air injection ports 20. The plurality of air injection ports 20 may be offset downstream from a downstream surface 30 of the nozzle cap 26.

As shown in FIGS. 3 and 4, the fuel burner system 10 may include one or more third fuel injection ports 32 positioned radially inward of the first fuel injection port 14. In at least one embodiment, the fuel burner system 10 may include a plurality of third fuel injection ports 32 positioned radially inward of the first fuel injection port 14 and may form a ring of third fuel injection ports 32. The plurality of third fuel injection ports 32 may number more than the first fuel injection port 14. In at least one embodiment, the plurality of third fuel injection ports 32 may be formed by eighteen third fuel injection ports 32. In other embodiments, another number of third fuel injection ports 32 may be used. The third fuel injection port 32 may be smaller than the second fuel injection port 16. In at least one embodiment, the diameter of an outlet 34 of the third fuel injection port 32 may be smaller than the diameter of an outlet 36 of the second fuel injection port 16. The third fuel injection ports 32 may have circular outlets 34.

In at least one embodiment, the first or second fuel injection ports 14, 16 may form a first fuel injection stage 38. The third fuel injection ports 32 may form a second fuel injection stage 40. in yet another embodiment, the first and second fuel injection ports 14, 16 together may form the first fuel injection stage 38, and the third fuel injection ports 32 may form the second fuel injection stage 40.

During use, fuel is emitted into the combustor housing 24 via the first injection stage 38. In at least one embodiment, between about 80 percent and about 90 percent of total fuel injection into the combustor 18 may occur through the first fuel injection stage 38. The fuel emitted from the first fuel injection stage 38 may flow from the first and second fuel injection ports 14, 16. The fuel flowing from the first fuel injection stage 38 may be controlled with one or more valves or other appropriate device to regulate fuel flow therefrom, and the second fuel injection stage 40 may be controlled with one or more valves or other appropriate device to regulate fuel flow therefrom. Thus, the first and second fuel injection stages 38, 40 may be controlled separately by independent fuel valves. The fuel flowing from the first fuel injection port 14 mixes with air emitted from the air injection ports 20 proximate to the first fuel injection ports 14. With the air injection ports 20 being circumferentially aligned with the first fuel injection ports 14 and being larger than the second fuel injection ports 16, the fuel is mixed with the air better than conventional systems resulting in lower NOx emissions and lower flame temperatures. In addition, the smaller second fuel injection ports 16 are positioned in an alternating manner between the larger first fuel injection ports 14. The second fuel injection ports 16 emit less fuel than the first fuel injection ports 16. As such, the regions 22 between the first fuel injection ports 16 experience less combustion and are cooler than conventional systems, allowing for lower temperatures of the combustor housing 24 and related components. The fuel burner system 10, thus, tailors the first and second fuel injection ports 14, 16 to optimize combustor temperatures, emissions, and combustion dynamics over a wide range of fuels. The fuel burner system 10 enables the syngas combustors 18 to operate with a wide range of fuel compositions, such as to accommodate a significant Wobbe Index variation or LHV variation. The fuel burner system 10 enables the syngas combustor 18 to use a wide range of fuel compositions without detrimental impacts that otherwise would substantially increase combustor basket temperatures in conventional systems.

The foregoing is provided for purposes of illustrating, explaining, and describing embodiments of this invention. Modifications and adaptations to these embodiments will be apparent to those skilled in the art and may be made without departing from the scope or spirit of this invention.

1-14. (canceled)

15. A fuel burner system for a turbine engine, comprising:
at least one combustor formed from a combustor housing and at least one nozzle cap; and
wherein the at least one nozzle cap includes at least one first fuel injection port and at least one second fuel injection port, wherein the at least one first fuel injection port is circumferentially aligned with at least one air injection port when view upstream along a longitudinal axis of the at least one combustor.

16. The fuel burner system of claim 15, wherein the at least one first fuel injection port and the at least one second fuel injection port are connected to independent fuel supply lines that are each controlled with separate valves.

17. The fuel burner system of claim 15, wherein the at least one first fuel injection port is larger than the at least one second fuel injection port.

18. The fuel burner system of claim 17, wherein the at least one first fuel injection port comprises a plurality first fuel injection ports forming a circular pattern on the at least one nozzle cap.

19. The fuel burner system of claim 18, wherein the at least one second fuel injection port comprises a plurality second fuel injection ports forming a circular pattern on the at least one nozzle cap.

20. The fuel burner system of claim 19, wherein each of the at least one first fuel injection ports is aligned with at least one air injection port.

21. The fuel burner system of claim 19, wherein the plurality of first fuel injection ports and the plurality of second fuel injection ports are positioned in an alternating, circular pattern.

22. The fuel burner system of claim 15, wherein the at least one air injection port is offset downstream from a downstream surface of the at least one nozzle cap.

23. The fuel burner system of claim 15, wherein the at least one air injection port is formed from a plurality of air injection ports circumferentially aligned with the at least one first fuel injection port.

24. The fuel burner system of claim 23, wherein the plurality of air injection ports are offset downstream from a downstream surface of the at least one nozzle cap.

25. The fuel burner system of claim 15, further comprising at least one third fuel injection port positioned radially inward of the at least one first fuel injection port.

26. The fuel burner system of claim 25, wherein the at least one third fuel injection port comprises a plurality of third fuel injection ports positioned radially inward of the at least one first fuel injection port and forming a ring of third fuel injection ports.

27. The fuel burner system of claim 25, wherein the at least one third fuel injection port is smaller than the at least one second fuel injection port.

28. The fuel burner system of claim 25, wherein the at least one first fuel injection port and the at least one second fuel injection port are controlled via at least one supply line and valve and the at least one third fuel injection port is controlled via at least one supply line and valve.

29. A fuel burner system for a turbine engine, comprising:
at least one combustor formed from a combustor housing and at least one nozzle cap;
wherein the at least one nozzle cap includes a plurality of first fuel injection ports and a plurality of second fuel injection ports, wherein at least one of the plurality of first fuel injection ports is larger than at least one of the plurality of second fuel injection ports and wherein at least one first fuel injection ports is circumferentially aligned with at least one air injection port when viewed upstream along a longitudinal axis of the at least one combustor; and
wherein the at least one first fuel injection port and the at least one second fuel injection port are connected to independent fuel supply lines that are each controlled with separate valves.

30. The fuel burner system of claim 29, further comprising at least one third fuel injection port positioned radially inward of the at least one first fuel injection port, wherein the at least one third fuel injection port is smaller than the at least one second fuel injection port.

31. The fuel burner system of claim 30, wherein the at least one third fuel injection port comprises a plurality of third fuel injection ports positioned radially inward of the at least one first fuel injection port and forming a ring of third fuel injection ports.

32. The fuel burner system of claim 29, wherein each of the at least one first fuel injection ports is aligned with at least one air injection port, and wherein the plurality of first fuel injection ports and the plurality of second fuel injection ports are positioned in an alternating, circular pattern.

33. The fuel burner system of claim 29, wherein the at least one air injection port is offset downstream from a downstream surface of the at least one nozzle cap, wherein the at least one air injection port is formed from a plurality of air injection ports circumferentially aligned with the at least one first fuel injection port, and wherein the plurality of air injection ports are offset downstream from a downstream surface of the at least one nozzle cap.

34. A fuel burner system for a turbine engine, comprising:
at least one combustor formed from a combustor housing and at least one nozzle cap;
wherein the at least one nozzle cap includes a plurality of first fuel injection ports and a plurality of second fuel injection ports, wherein at least one of the plurality of first fuel injection ports is larger than at least one of the plurality of second fuel injection ports and wherein each of the plurality of first fuel injection ports is circumferentially aligned with at least one air injection port when viewed upstream along a longitudinal axis of the at least one combustor;
wherein the at least one first fuel injection port and the at least one second fuel injection port are connected to independent fuel supply lines that are each controlled with separate valves;
at least one third fuel injection port positioned radially inward of the at least one first fuel injection port, wherein the at least one third fuel injection port is smaller than the at least one second fuel injection port; and
wherein the plurality of first fuel injection ports and the plurality of second fuel injection ports are positioned in an alternating, circular pattern.
